(19) United States
(12) Patent Application Publication
(10) Pub. No.: US 2005/0200742 A1
(43) Pub. Date: Sep. 15, 2005

(54) Optical low pass filter switching apparatus of digital camcorder

(75) Inventors: Kwang-Hyok Park, Suwon-si (KR); Nam-Il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/045,143

(22) Filed: Jan. 31, 2005

(30) Foreign Application Priority Data
Mar. 10, 2004 (KR) 2004-16053

(51) Int. Cl. H04N 5/225

(52) U.S. Cl. 348/360

(57) ABSTRACT

An OLPF switching apparatus has an OLPF fixing part that is pivotably fixed to a housing of a lens assembly and has a first OLPF for passing light of a first wavelength among incoming image information, and a second OLPF for passing light of a second wavelength among the incoming image information. A switching lever is pivotably fixed to the housing and has a first end which moves in relation to the movement of the OLPF fixing part to selectively locate the OLPF fixing part in one of a first OLPF setting position and a second OLPF setting position. An operating part is slidably disposed in an outer casing which seals the lens assembly. A link part is connected with the operating part and a second end of the switching lever forming a predetermined angle with respect to the first end.

### CROSS-REFERENCE TO RELATED APPLICATIONS

This application claims the benefit under 35 U.S.C. §119(a) of Korean Patent Application No. 2004-16053, filed on Mar. 10, 2004, in the Korean Intellectual Property Office, the entire disclosure of which is hereby incorporated by reference.

### BACKGROUND OF THE INVENTION

1. Field of the Invention

The present invention relates to an optical low pass filter (OLPF) switching apparatus of a digital camcorder. More particularly, the present invention relates to an OLPF switching apparatus of a digital camcorder capable of switching a daytime OLPF and a nighttime OLPF when necessary.

2. Description of the Related Art

In general, a digital camcorder is divided into a color camcorder capable of realizing a color image and a combined color and monochrome camcorder capable of realizing color and monochrome images.

During the daytime when the ambient light is sufficiently high, the combined color and monochrome camcorder uses the ambient light to realize a color image, and therefore, it does not require a separate illuminator. Meanwhile, during the nighttime or in a dark area where a human being cannot perceive a subject, the combined color and monochrome camcorder uses a strobo or flash as a supplementary illuminator to realize a color image, and uses a plurality of infrared light emitting diodes (IR LEDs) projecting infrared light from both sides of a lens in a frontal direction to realize a monochrome image.

The combined color and monochrome camcorder uses visible rays ranging from about 400 to 700 nm which a human being can detect and match when realizing a color image, and it uses infrared rays of about 900 nm in realizing a monochrome image. However, a photographing element used in the combined color and monochrome camcorder as a photoelectric conversion sensor for converting light to electric signals, such as a charge-coupled device (CCD) or a complementary metal oxide semiconductor (CMOS), is operated regardless of whether the combined color and monochrome camcorder realize a color image or a monochrome image. Therefore, in the daytime when both the visible rays and the infrared rays are incident through a lens, focal distances are different due to a difference between wavelengths of the visible light rays and the infrared rays, and thus, a focus tilting occurs.

In order to solve this problem, the combined color and monochrome camcorder has used an apparatus and method capable of switching a daytime OLPF, which blocks the infrared rays ahead of the photographing element and passes only the visible rays, and a nighttime OLPF, which only passes the infrared rays.

FIGS. 1 and 2 illustrate an OLPF switching apparatus 10 used in a general combined color and monochrome camcorder.

The OLPF switching apparatus 10 comprises an OLPF fixing part (not shown) pivotably fixed to a rear fixing plate 7 (shown in FIG. 2) of a housing 4 of a lens assembly 3 and having a daytime OLPF (not shown) and a nighttime OLPF, a switching lever 11 pivotably fixed to the rear fixing plate 7 of the housing 4 to turn the OLPF fixing part between a daytime OLPF setting position where the daytime OLPF is located on a picture information conveyance path between the lens 5 and the photographing element (not shown) and a nighttime OLPF setting position where the nighttime OLPF is located on the picture information conveyance path between the lens 5 and the photographing element, and an operating part 15 for operating the switching lever 11 to move the OLPF fixing part between the daytime OLPF setting position and the nighttime OLPF setting position.

The operating part 15 comprises a knob 17 protruding from an outer casing 1 of the camcorder to the outside and movably disposed in a slider slot 1a formed in the outer casing 1, and a slider 19 held in a holder 22 is formed in the outer casing 1 and moving up and down therein.

A protruding member 21 protruding from the inner side of the slider 19 has a pivoting hole 21a defined therein for pivotably supporting an axially-protruding end 11a of the switching lever 11.

Operation of the OLPF switching apparatus 10 with the above construction is as follows.

It is assumed that the OLPF filter switching apparatus 10 is in a daytime mode to realize a color image. That is, in the daytime mode, as shown by dotted lines of FIG. 2, the knob 17 of the operating part 15 is located at a lower position to set the OLPF fixing part in the daytime OLPF setting position. In this state, when an operator wants to switch to the nighttime OLPF according to a variation in illumination or switch from the daytime mode for color image realization to the nighttime mode for monochrome image realization to achieve a special effect, the operator slides the knob 17 of the operating part 15 up to set the OLPF fixing part in the nighttime OLPF setting position as illustrated in solid lines of FIG. 2.

As a result, the protruding member 21 inwardly protruding from the slider 19 moves up, and accordingly, the axially-protruding end 11a of the switching lever 11 pivotably received in the pivoting hole 21a of the protruding member 21 moves up, whereby pivoting the switching lever 11.

As the switching lever 11 turns, the OLPF fixing part connected to the opposite side of the switching lever 11 to the axially-protruding end 11a turns accordingly, and moves to the nighttime OLPF setting position where the nighttime OLPF is located on the picture information conveyance path between the lens 5 and the photographing element. As a result, the OLPF switching apparatus 10 switches to the nighttime mode.

When the operator wants to return the OLPF switching apparatus 10 back to the daytime mode after photographing a subject in the nighttime mode, the operator slides down the knob 17 of the operating part 15. Then, the protruding member 21, the switching lever 11, and the OLPF fixing part are operated in the reverse manner as described above, so that the OLPF fixing part is moved from the nighttime OLPF setting position to the daytime OLPF setting position. As a result, the OLPF switching apparatus 10 switches to the daytime mode.

However, in the conventional OLPF switching apparatus 10, the protruding member 21 of the operating part 15 moves up and down along the outer casing 1 in a substantially linear pattern, while the switching lever 11 connected with the protruding member 21 moves in a rotational pattern. That is, since the protruding member 21 and the switching lever 11 having different movement trajectories are directly connected with each other, when the protruding member 21 is moved up and down by the knob 17 to switch the daytime mode and the nighttime mode, the linear movement of the protruding member 21 is not smoothly transformed into the rotational movement of the switching lever 11.

If the movement of the protruding member 21 is not smoothly transmitted to the switching lever 11 as described above, the user feels resistance in sliding the knob 17. Also, if a manipulation mistake occurs or is repeated often, the axially-protruding end 11a connecting the protruding member 21 and the switching lever 11 is damaged and thus the product becomes unreliable.

### SUMMARY OF THE INVENTION

The present invention has been developed in order to solve the above problems in the related art. Accordingly, an aspect of the present invention is to provide an OLPF switching apparatus of a digital camcorder, which is capable of achieving a smooth operation and prevent the damage to camcorder parts and the subsequent deterioration of product reliability.

The above aspect is achieved by providing an OLPF switching apparatus of a digital camcorder. The OLPF switching apparatus comprises: an OLPF fixing part pivotably fixed to a lens housing assembly and having a first OLPF and a second OLPF, the first OLPF passes light of a first wavelength from among the incoming image information, the second OLPF passes light of a second wavelength area among the incoming image information; a switching lever pivotably fixed to the housing and having a first end which is linked to the OLPF fixing part to selectively locate the OLPF fixing part in one of a first OLPF setting position, where the first OLPF is located in an image information conveyance path, and a second OLPF setting position, where the second OLPF is located in the image information conveyance path; an operating part slidably disposed in an outer casing, which seals the lens assembly; and a link part connected to the operating part and a second end of the switching lever, forming a predetermined angle with respect to the first end, for transforming the movement of the operating part into tangential movement along a rotation trajectory from the second end of the switching lever.

The link part may comprise one end pivotably connected to the operating part and the other end having a movement hole in which the second end of the switching lever is movably received.

The operating part may comprise: a knob protruding from a sidewall of the outer casing to the outside and moving in a slider slot defined in the outer casing; a slider connected with the knob and sliding up and down in an inclined manner; and a protruding member protruding from the inner side of the slider and having a pivoting shaft on which one end of the link part pivots.

### BRIEF DESCRIPTION OF THE DRAWING FIGURES

The above aspect and other advantages of the various embodiments of the present invention will be more apparent by describing an embodiment of the present invention with reference to the accompanying drawing figures, in which:

FIG. 1 is a front view showing an OLPF switching apparatus of a conventional digital camcorder;

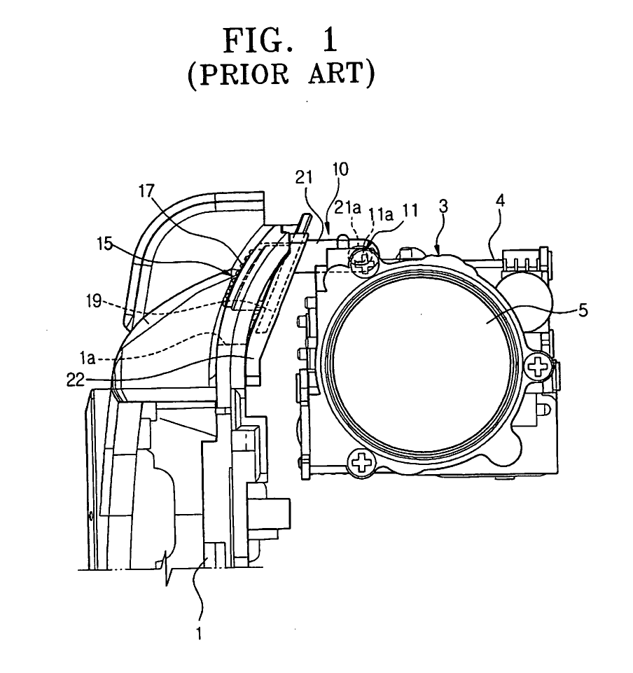

FIG. 2 is a rear view showing the OLPF switching apparatus of FIG. 1;

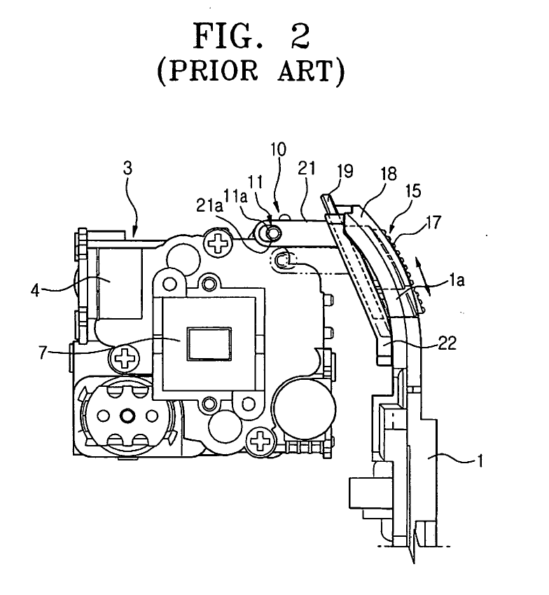

FIG. 3 is a front view showing an OLPF switching apparatus of a digital camcorder according to an embodiment of the present invention;

FIG. 4 is a rear view showing the OLPF switching apparatus of FIG. 3; and

FIGS. 5A and 5B are front views showing the rear side fixing plate of the housing of the lens assembly to explain operation of the OLPF switching apparatus of FIG. 3.

In the drawing figures, it will be understood that like reference numerals refer to like features and structures throughout the figures.

### DETAILED DESCRIPTION OF THE EXEMPLARY EMBODIMENTS

Hereinafter, an OLPF switching apparatus of a digital camcorder according to an embodiment of the present invention will be described in detail with reference to the accompanying drawing figures.

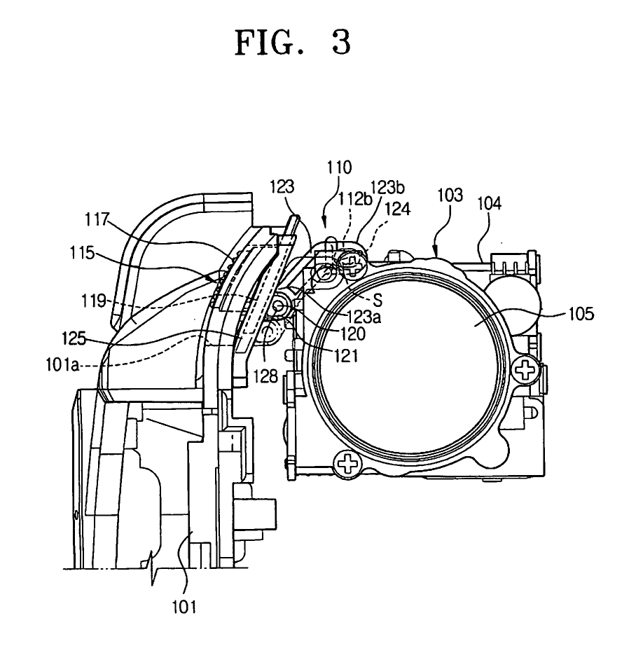

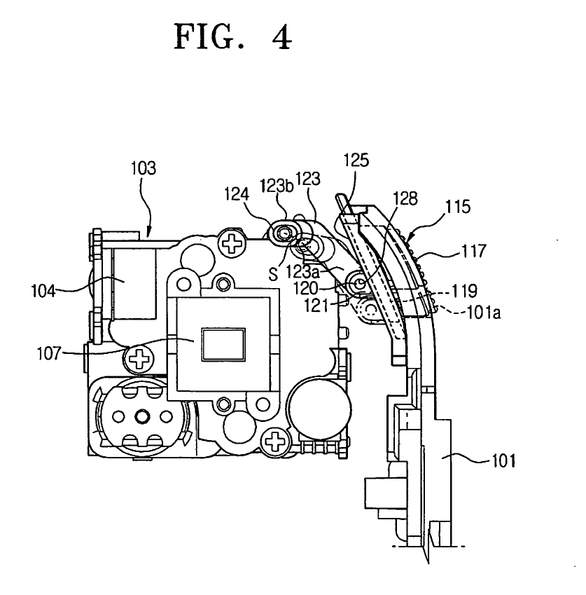

FIGS. 3 and 4 illustrate an OLPF switching apparatus 110 used in a combined color and monochrome digital camcorder according to an embodiment of the present invention.

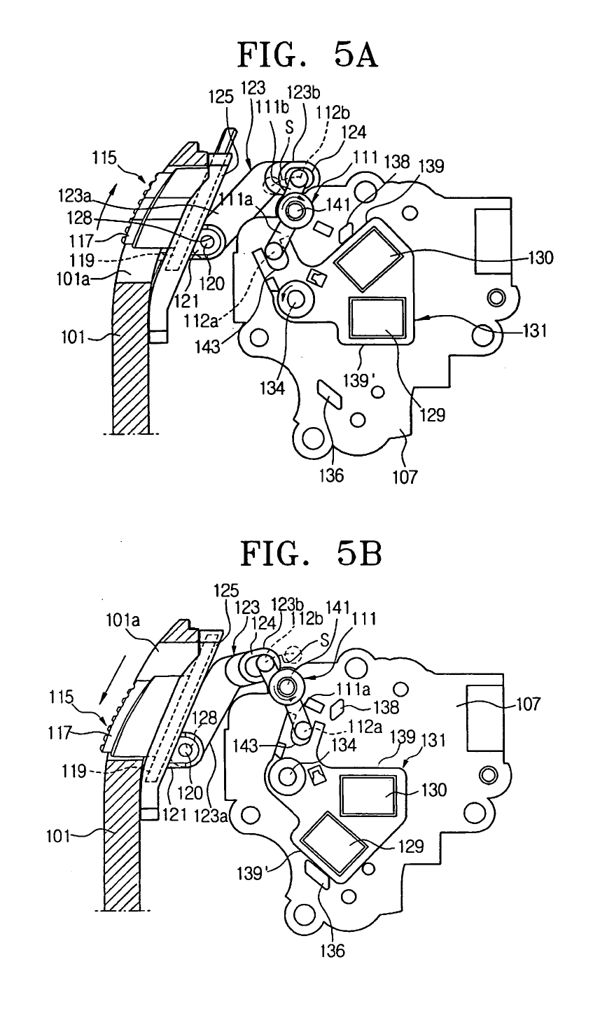

The OLPF switching apparatus 110 comprises an OLPF fixing part 131 (see FIG. 5A), a switching lever 111 (see FIG. 5A), an operating part 115, and a link part 123. The OLPF fixing part 131 comprises a daytime OLPF 130 (see FIG. 5A) and a nighttime OLPF 129, which are disposed apart from each other by a predetermined distance, and is preferably pivotably fixed to a rear side fixing plate 107 of a housing 104 of a lens assembly 103. The switching lever 111 is preferably pivotably fixed to the rear side fixing plate 107 of the housing 104, and has a first end 111a, which is linked with the OLPF fixing part 131 to turn the OLPF fixing part 131 between a daytime OLPF setting position (See dotted lines of FIG. 4, and FIG. 5B) and a nighttime OLPF setting position (See solid lines of FIG. 4, and FIG. 5A). When the OLPF fixing part 131 is set in the daytime OLPF setting position, the daytime OLPF 130 is located in the image information conveyance path between a lens 105 and a photographing element (not shown). On the other hand, when the OLPF fixing part 131 is set in the nighttime OLPF setting position, the nighttime OLPF 129 is located in the image information conveyance path between the lens 105 and the photographing element. The operating part 115 is slidably disposed in an outer casing 101 which seals the lens assembly 103. The link part 123 is connected with the operating part 115 and a second end 111b of the switching lever 111 which forms a predetermined angle with respect to the first end 111a. The link part 123 transforms the movement of the operating part 115 into a tangential movement S in a rotational trajectory of the second end 111b of the switching lever 111.

As shown in FIGS. 5A and 5B, the OLPF fixing part 131 has an upper portion pivotably fixed to a first shaft 134 formed on the rear side fixing plate 107 of the housing 104 to turn on the first shaft 134. The OLPF fixing part 131 has side surfaces 139 and 139′ contacting first and second stoppers 136 and 138 which are formed on the rear side fixing plate 107 to prevent the OLPF fixing part 131 from moving further than the daytime OLPF setting position and the nighttime OLPF setting position.

The daytime OLPF 130 is an infrared rays cut filter for removing light in the infrared spectrum from the image information and passing only the light in the visible spectrum therethrough, while the nighttime OLPF 130 is a dummy filter for passing all of the light of the visible s and the infrared spectrums.

The switching lever 111 is pivotably fixed to a second shaft 141 formed on the rear side fixing plate 107 of the housing 104. The first end 111a of the switching lever 111 has a first axially protruding part 112a inserted in a first movement hole 143, which is defined in the upper portion of the OLPF fixing part 131 adjacent the first shaft 134 and has one side open. The OLPF fixing part 131 is turned by the first axially-producing part 112a.

The operating part 115 comprises a knob 117 protruding from a sidewall of the outer casing 101 of the camcorder to the outside and movably disposed in a sliding slot 101a formed in the sidewall of the outer casing 101, and a slider 119 held in a holder 125 formed in the outer casing 101 and moving up and down therein.

Preferably, the slider 119 slides up and down in an inclined manner.

The slider 119 has a protruding member 121 protruding from the inner side thereof toward the inner side of the outer casing 101. The protruding member 121 has a pivoting shaft 120 inserted in a fixing hole 128 formed in one end 123a of the link part 123.

One end 123a of the link part 123 is pivotably connected with the pivoting shaft 120 of the protruding member 121 of the operating part 115, and the other end 123b of the link part 123 is preferably elbow-shaped and has a second movement hole 124 in which a second axially-protruding part 112b formed at the second end 111b of the switching lever 111 is movably received.

Accordingly, as the protruding member 121 is moved up and down by the knob 117 in a linear movement, the other end 123b of the link part 123 moves in a tangential direction along the rotation trajectory S of the second axially-protruding part 112b of the second end 111b of the switching part 111, thereby pushing and pulling the switching part 111. As a result, the slider 119 of the operating part 115 and the knob 117 can be smoothly moved.

Operation of the OLPF switching apparatus 110 with the above construction is described in greater detail with reference to FIGS. 4 to 5B.

If the OLPF switching apparatus 110 is in the daytime mode for the color image realization, the knob 117 of the operating part 115 is located at the lower position and the OLPF fixing part 131 is located in the daytime OLPF setting position as shown in FIG. 5B. In this state, when an operator wants to switch to the nighttime OLPF because of variation in illumination or switch the daytime mode to the nighttime mode for the monochrome image realization to achieve a special effect, the operator slides up the knob 117 of the operating lever 115 to set the OLPF fixing part 131 in the nighttime OLPF setting position.

As a result, the protruding member 121 of the slider 119 moves up, and thus, one end 123a of the link part 123 pivotably connected with the pivoting shaft 120 of the protruding member 121 also moves up.

The other end 123b of the link part 120, which has the second movement hole 124 engaged with the second axially-protruding part 112b of the second end 111b of the switching lever 111, moves in a tangential direction along the rotation trajectory of the second axially-protruding part 112b, thereby moving up the second axially-protruding part 112b. As a result, the switching lever 111 turns on the second shaft 141 in a clockwise direction as shown in FIG. 5A.

As the switching lever 111 turns in the clockwise direction, the first axially-protruding part 112a of the first end 11a inserted in the first movement hole 143 turns the OLPF fixing part 131 about the first shaft 134 in a counter clockwise direction.

Accordingly, the nighttime OLPF 129 moves to the nighttime OLPF setting position (FIG. 5A) where it is located on the image information conveyance path between the lens 105 and the photographing element until the side surface 139 of the OLPF fixing plate 131 is blocked from moving by the second stopper 138. As a result, the OLPF switching apparatus 110 is set in the nighttime mode.

When the operator wants to return the OLPF switching apparatus 110 back to the daytime mode after photographing in the nighttime mode, he or she slides down the knob 117 of the operating lever 115. Accordingly, the protruding member 121, the link part 123, the switching lever 111 and the OLPF fixing part 131 are operated in the reverse order as described above, so that the OLPF fixing part 131 switches from the nightime OLPF setting position (FIG. 5A) to the daytime OLPF setting position (FIG. 5B) and the OLPF switching apparatus 110 is set in the daytime mode.

As described above, when the digital camcorder switches an OLPF suitable to the variations in daytime illumination or nighttime illumination or for the purpose of a special effect, the OLPF switching apparatus 110 smoothly transforms the up and down linear movement of the knob 117 of the operating part 115 into the rotational movement of the switching lever 111. Accordingly, the knob 117 of the operating part 115 moves smoothly, and thus, the related parts are prevented from being damaged and the reliability of a product can be maintained.

The foregoing embodiments and advantages are merely exemplary and are not to be construed as limiting the present invention. The description of the embodiments of the present invention is intended to be illustrative, and not to limit the scope of the claims. Many alternatives, modifications, and variations will be apparent to those skilled in the art.

1. An Optical Low Pass Filter (OLPF) switching apparatus of a digital camcorder, comprising:
an OLPF fixing part pivotably fixed to a housing of a lens assembly and having a first OLPF and a second OLPF, the first OLPF for passing light of a first wavelength spectrum range among incoming image information, the second OLPF for passing light of a second wavelength spectrum range among the incoming image information;
a switching lever pivotably fixed to the housing and having a first end which is linked with the OLPF fixing part to selectively locate the OLPF fixing part in one of a first OLPF setting position where the first OLPF is located on an image information conveyance path and a second OLPF setting position where the second OLPF is located on the image information conveyance path;
an operating part slidably disposed in an outer casing which seals the lens assembly; and
a link part connected with the operating part and a second end of the switching lever forming a predetermined angle with respect to the first end, for transforming the movement of the operating part into a tangential direction movement of a rotation trajectory of the second end of the switching lever.

2. The OLPF switching apparatus as claimed in claim 1, wherein the link part comprises one end pivotably connected to the operating part and the other end having a movement hole in which the second end of the switching lever is movably received.

3. The OLPF switching apparatus as claimed in claim 2, wherein the operating part comprises:
a knob protruding from a sidewall of the outer casing to the outside and moving in a slider slot defined in the outer casing;
a slider connected with the knob and sliding up and down in an inclined manner; and
a protruding member protruding from the inner side of the slider and having a pivoting shaft on which one end of the link part pivots.

4. The OLPF switching apparatus of claim 2, wherein the link part transforms the movement of the operating part into a tangential movement along a rotational trajectory from the second end of the switching lever.

5. A method of switching an Optical Low Pass Filter (OLPF) in a digital camcorder, comprising the steps of:
pivotably attaching an OLPF fixing part to a housing of a lens assembly, the OLPF fixing part having a first OLPF and a second OLPF, the first OLPF for passing light of a first wavelength spectrum range among incoming image information, the second OLPF for passing light of a second wavelength spectrum range among the incoming image information;
pivotable attaching a switching lever to the housing, the switching lever having a first end which is linked with the OLPF fixing part to selectively locate the OLPF fixing part in one of a first OLPF setting position where the first OLPF is located on an image information conveyance path and a second OLPF setting position where the second OLPF is located on the image information conveyance path;
slidably disposing an operating part in an outer casing that seals the lens assembly; and
connecting the operating part and a second end of the switching lever to move operating part in a tangential direction movement of a rotation trajectory of the second end of the switching lever.

6. A method as claimed in claim 5, wherein the connecting step comprises connecting a link part with the operating part and a second end of the switching lever to form a predetermined angle with respect to the first end.

7. A method as claimed in claim 6, wherein the link part comprises one end pivotably connected to the operating part and the other end having a movement hole in which the second end of the switching lever is movably received.
